(19) United States
(12) Patent Application Publication
(10) Pub. No.: US 2026/0327096 A1
(43) Pub. Date: Oct. 22, 2026

(54) SEAWATER DESALINATION SYSTEMS FOR COMPREHENSIVE UTILIZATION OF MARINE ENERGY

(71) Applicant: GUANGDONG OCEAN UNIVERSITY, Zhanjiang (CN)

(72) Inventors: Qing XU, Zhanjiang (CN); Huiyuan SUN, Zhanjiang (CN); Haowei LI, Zhanjiang (CN)

(73) Assignee: GUANGDONG OCEAN UNIVERSITY, Zhanjiang (CN)

(21) Appl. No.: 19/337,898

(22) Filed: Sep. 23, 2025

Related U.S. Application Data
(63) Continuation of application No. PCT/CN2025/119640, filed on Sep. 8, 2025.

(30) Foreign Application Priority Data
Apr. 17, 2025 (CN) 202510479637.1

(51) Int. Cl. C02F 1/14; C02F 1/48; C02F 103/08

(52) U.S. Cl. CPC C02F 1/14; C02F 1/48; C02F 2103/08; C02F 2201/004; C02F 2201/005; C02F 2201/009; C02F 2209/03

(57) ABSTRACT

A seawater desalination system for comprehensive utilization of marine energy is provided, including a mounting rod. A sliding slot is formed throughout a surface of the mounting rod, a sliding sleeve is slidably sleeved on an outer side of the mounting rod, and a regulating box is welded at a bottom end of the sliding sleeve; a fresh water box is sleeved on the outside of the mounting rod, and a conversion pump connecting a manifold is mounted at a bottom end of the fresh water box; a solar panel is provided at a top end of the mounting rod; and a fixing block connecting a fixing rod is welded at a top end of the sliding sleeve, a generator and a positioning electromagnet are connected to end faces of the fixing rod, and power fan blades are connected to a rotating end of the generator.

### CROSS-REFERENCE TO RELATED APPLICATIONS

This application is a Continuation of International Application No. PCT/CN2025/119640, filed on Sep. 8, 2025, which claims priority to Chinese Patent Application No. 202510479637.1, filed Apr. 17, 2025, the entire contents of which are incorporated herein by reference.

### TECHNICAL FIELD

This disclosure relates to technical field of seawater desalination, and in particular to a seawater desalination system for comprehensive utilization of marine energy.

### BACKGROUND

Seawater desalination refers to a process of removing salts from seawater and converting the seawater into fresh water usable by humans. The distillation method is a common way for desalinate seawater, which obtains high purity fresh water by heating the seawater and condensing the water vapor. In applications such as islands, offshore drilling platforms, and ocean-going vessels, seawater desalination devices can utilize the distillation method to provide a stable fresh water supply to safeguard human needs for daily life and production.

However, the distillation method has high energy consumption, so the energy consumption of the seawater desalination device needs to supplement by utilizing marine energy (e.g., wind energy, tidal energy, etc.). Current seawater desalination devices utilize the marine energy in a single way, which cannot fully utilize natural resources of ocean and is greatly affected by climate, resulting in low seawater desalination efficiency and an inability to provide sufficient fresh water.

Therefore, it is necessary to provide a seawater desalination system for comprehensive utilization of marine energy, to increase the ways in which the seawater desalination device utilizes the marine energy, and to fully utilize natural resources of ocean under a plurality of climatic conditions, thereby improving seawater desalination efficiency.

### SUMMARY

One or more embodiments of the present disclosure provide a seawater desalination system for the comprehensive utilization of marine energy. The system includes a mounting rod, an integrated power generation assembly being mounted on an outer side of the mounting rod; the integrated power generation assembly including a sliding slot; wherein the sliding slot is formed throughout a surface of the mounting rod, a sliding sleeve is slidably sleeved on the outer side of the mounting rod, and a regulating box is welded at a bottom end of the sliding sleeve; a front water pipe is connected to one end face of the regulating box, and a rear water pipe is connected to the other end face of the regulating box; a spring water pipe is mounted on an inside of the mounting rod, a connecting pipe is connected to one end of the spring water pipe, and the connecting pipe is in communication with an inner cavity of the regulating box; an inside of the regulating box is provided with a restriction groove, and a restriction tube is welded at a middle position of the inside of the regulating box; a fixing block is welded at a top end of the sliding sleeve, a fixing rod is welded at one end of the fixing block, a generator is welded at one end of the fixing rod, power fan blades are connected to a rotating end of the generator, and a positioning electromagnet is mounted at a top end of the fixing block; a fresh water box is sleeved on the outside of the mounting rod, a conversion pump is mounted at a bottom end of the fresh water box, a manifold is connected to an output end of the conversion pump, the other end of the spring water pipe is connected to an input end of the conversion pump, and external air is input into the regulating box through the manifold, the spring water pipe, and the connecting pipe by the conversion pump, or seawater is input into the regulating box through the front water pipe and the rear water pipe by the conversion pump, to realize lifting and lowering of the power fan blades; and a support rod is welded at a top end of the mounting rod, a condensate panel is welded at a top end of the support rod, and a solar panel is mounted at a top end of the condensate panel.

In some embodiments, a battery pack is mounted at the bottom end of the fresh water box, and a plumbing chamber is provided on the inside of the mounting rod.

In some embodiments, a waterproof solenoid valve is mounted on an outer side of the front water pipe, and a filtering mesh is snap-fitted at an end of the front water pipe.

In some embodiments, a count of the fixing rod is two, and two fixing rods are symmetrically mounted on end surfaces of both sides of the fixing block.

In some embodiments, a rotating seat is welded on an end face of the fixing block, and a rotating rod is rotationally mounted on an inside of the rotating seat, and a floating ball is connected to one end of the rotating rod, and a toggle plate is welded at the other end of the rotating rod; and a rising pressure switch is mounted on one end face of the fixing block, and a falling pressure switch is mounted on the other end face of the fixing block at a position symmetrical to the rising pressure switch.

In some embodiments, the connecting pipe is slidably connected to the mounting rod through the sliding slot; and an inner diameter of the restriction groove is equal to an inner diameter of the sliding sleeve.

In some embodiments, the restriction tube is welded to at a position on the inside of the regulating box corresponding to the restriction groove; and an output end of the generator is connected to an input end of the battery pack, and a contact surface of the sliding sleeve and a contact surface of the mounting rod are both smooth surfaces.

In some embodiments, an evaporation assembly is mounted at a top end of the fresh water box; the evaporation assembly includes a fresh water chamber; the fresh water chamber is provided at the top end of the fresh water box, at least one evaporation cell is mounted on an inside of the fresh water chamber, a seawater chamber is provided on an inside of each of the at least one evaporation cell, heating resistance wires are mounted on an inner side of the seawater chamber, an outer side of each of the at least one evaporation cell is connected with a wastewater connecting pipe, a wastewater discharge pipe is welded at a bottom position of an outside of the wastewater connecting pipe, and a wastewater solenoid valve is sleeved on an outside of the wastewater discharge pipe; a fresh water pipe is connected to the bottom end of the fresh water box, a snap-in groove is provided at a middle position of the bottom end of the fresh water box, and a water inlet hole is provided on the inside of each of the at least one evaporation cell; a deflector groove plate is welded at a bottom end of the condensate panel, a heat dissipation plate is mounted at a side of the top end of the condensate panel close to the solar panel, an outer side of the fresh water box is welded with a connecting bracket, an end of the connecting bracket is welded with a mounting bracket, and a condensate slot is provided at the bottom end of the condensate panel; and a waste water tank is provided at a connection position between the inside of each of the at least one evaporation cell and the wastewater connecting pipe, and a controller is mounted on the bottom end of the fresh water box.

In some embodiments, two evaporation cells are mounted, the two evaporation cells are symmetrically mounted on the inside of the fresh water box, and two ends of the wastewater connecting pipe are connected to the two evaporation cells, respectively.

In some embodiments, the waterproof solenoid valve, the positioning electromagnet, the rising pressure switch, the falling pressure switch, the conversion pump, input ends of the heating resistance wires, and an input end of the solar panel are electrically connected to an output end of t he controller, and an input end of the controller is electrically connected to an output end of the battery pack.

### BRIEF DESCRIPTION OF THE DRAWINGS

This disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating a structure of a seawater desalination system for comprehensive utilization of marine energy according to some embodiments of the present disclosure;

FIG. 2 is a schematic diagram illustrating a structure of an integrated power generation assembly according to some embodiments of the present disclosure;

FIG. 3 is a schematic diagram illustrating a structure of a spring water pipe according to some embodiments of the present disclosure;

FIG. 4 is a schematic diagram illustrating a structure of a restriction tube according to some embodiments of the present disclosure;

FIG. 5 is a schematic diagram illustrating a structure of a filtering mesh according to some embodiments of the present disclosure;

FIG. 6 is a schematic diagram illustrating a structure of power fan blades according to some embodiments of the present disclosure;

FIG. 7 is a schematic diagram illustrating a structure of a floating ball according to some embodiments of the present disclosure;

FIG. 8 is a schematic diagram illustrating a structure of a heat dissipation plate according to some embodiments of the present disclosure;

FIG. 9 is a schematic diagram illustrating a structure of a bottom end of a fresh water box according to some embodiments of the present disclosure;

FIG. 10 is a schematic diagram illustrating a structure of an evaporation assembly according to some embodiments of the present disclosure;

FIG. 11 is a schematic diagram illustrating a structure of a wastewater connecting pipe according to some embodiments of the present disclosure;

Reference numerals in the drawings are as follows: 1, mounting rod; 2, integrated power generation assembly; 201, sliding slot; 202, sliding sleeve; 203, regulating box; 204, spring water pipe; 205, connecting pipe; 206, restriction groove; 207, restriction tube; 208, front water pipe; 209, waterproof solenoid valve; 210, filtering mesh; 211, rear water pipe; 212, fixing block; 213, fixing rod; 214, generator; 215, power fan blade; 216, positioning electromagnet; 217, rotating seat; 218, rotating rod; 219, floating ball; 220, toggle plate; 221, rising pressure switch; 222, falling pressure switch; 223, fresh water box; 224, conversion pump; 225, manifold; 226, battery pack; 227, plumbing chamber; 3, evaporation assembly; 301, fresh water chamber; 302, evaporation cell; 303, seawater chamber; 304, heating resistance wire; 305, wastewater connecting pipe; 306, wastewater discharge pipe; 307, wastewater solenoid valve; 308, fresh water pipe; 309, snap-in groove; 310, water inlet hole; 311, support rod; 312, condensate panel; 313, deflector groove plate; 314, solar panel; 315, heat dissipation plate; 316, connecting bracket; 317, mounting bracket; 318, condensate slot; 319, waste water tank; 320, controller.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person ordinary skilled in the art to apply the present disclosure to other similar scenarios in accordance with these drawings without creative labor. Unless obviously obtained from the context or the context illustrates otherwise, the same numeral in the drawings refers to the same structure or operation.

As shown in the present disclosure and the claims, unless the context clearly suggests an exception, the terms “a”, “an”, and/or “the” do not refer specifically to the singular, but may also include the plural. In general, the terms “including” and “comprising” only suggest the inclusion of explicitly identified steps and elements that do not constitute an exclusive list, and the method or apparatus may also include other steps or elements.

This disclosure provides a seawater desalination system for comprehensive utilization of marine energy (hereinafter referred to as the seawater desalination system).

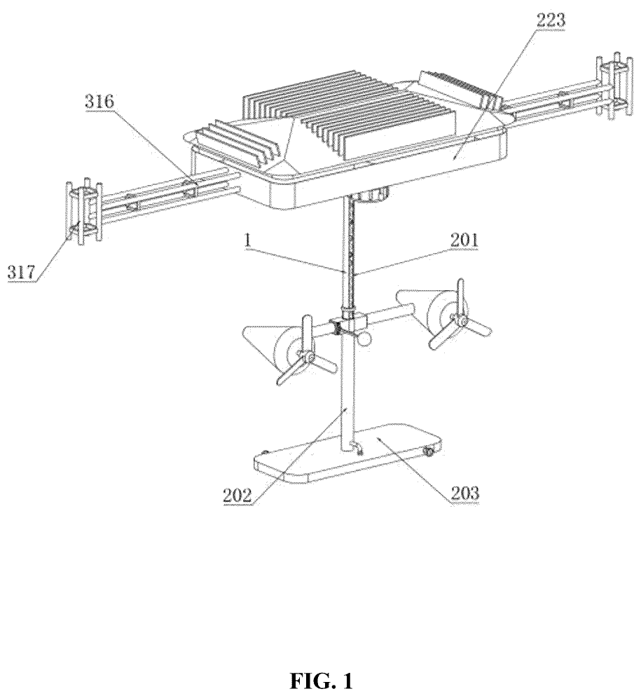

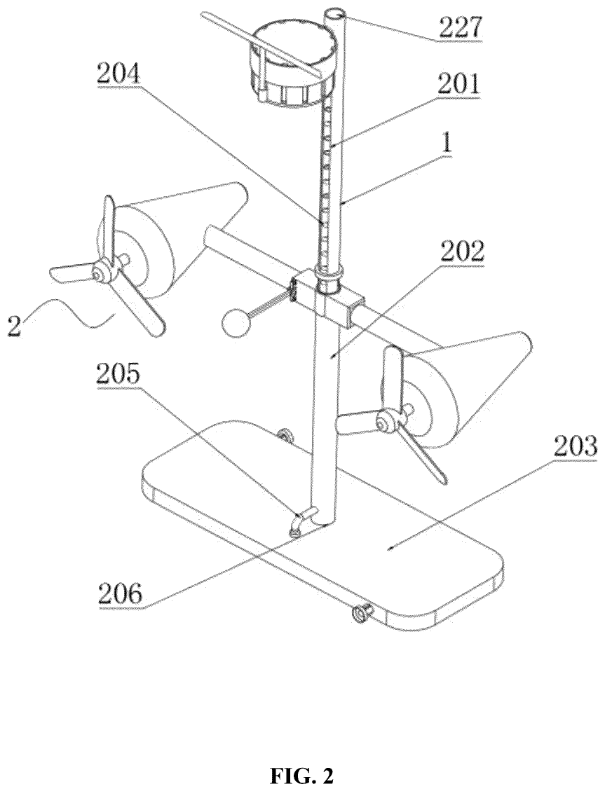

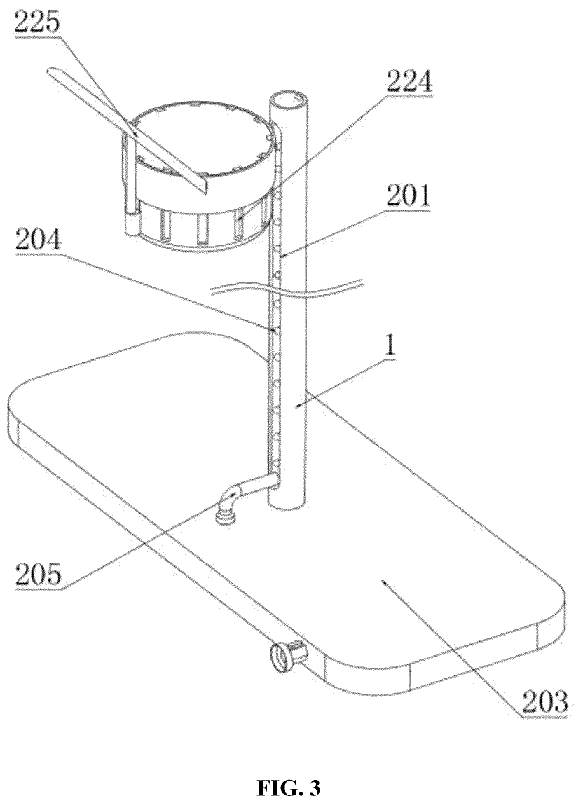

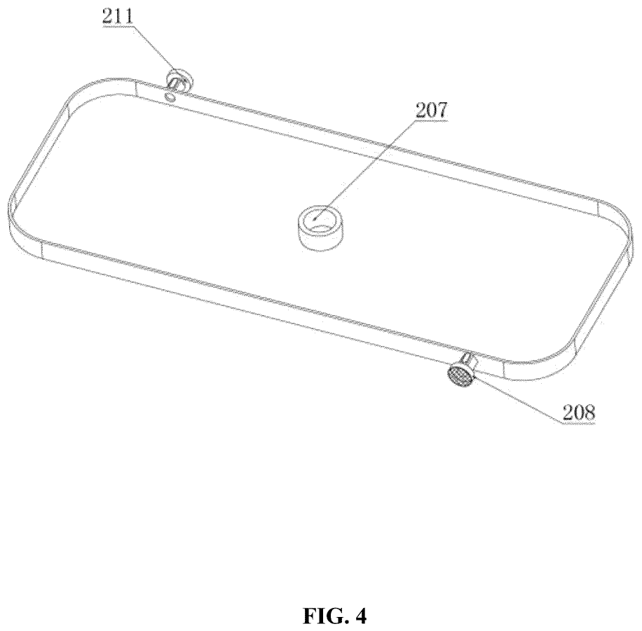

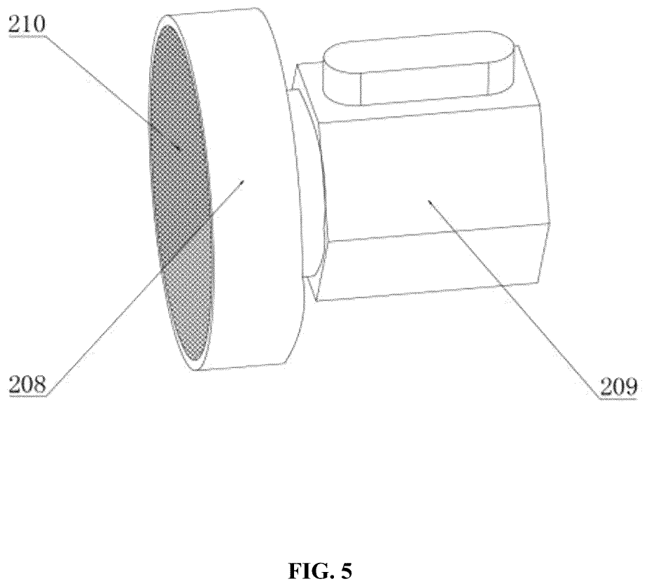

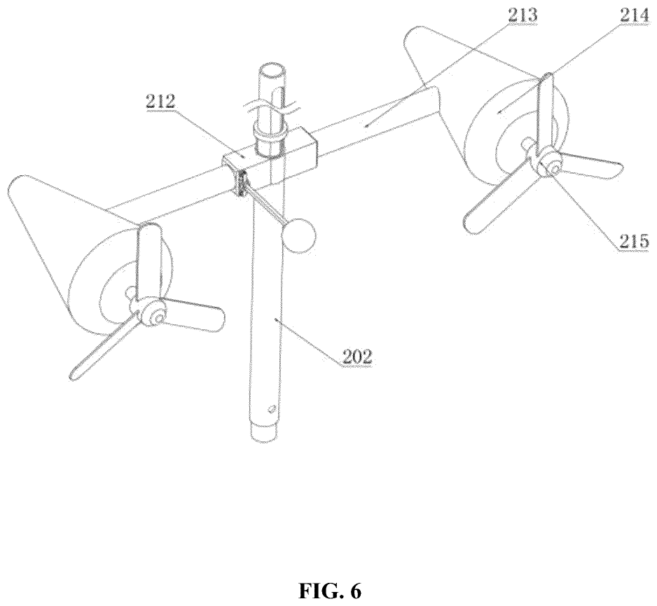

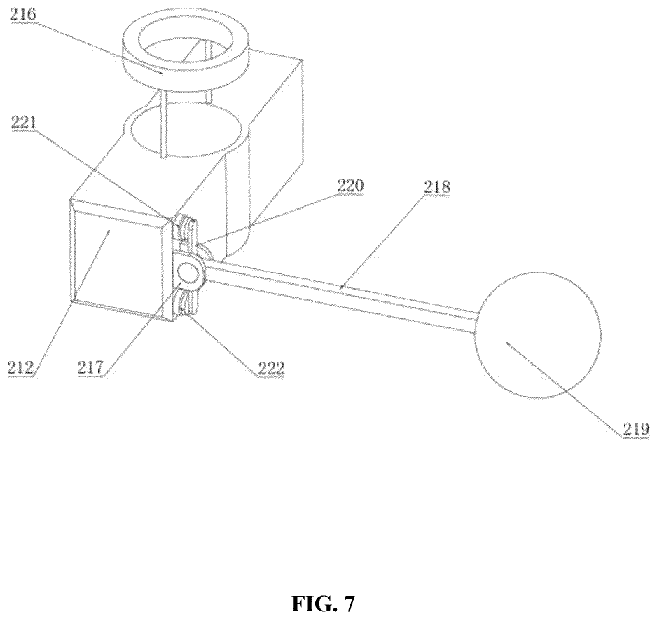

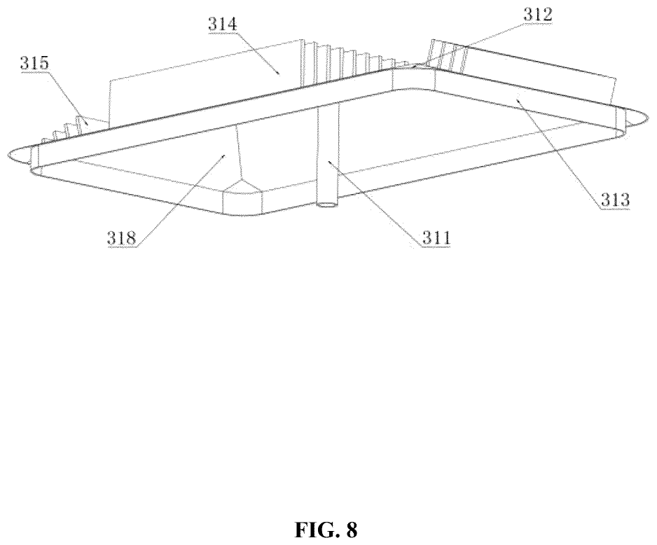

FIG. 1 is a schematic diagram illustrating a structure of a seawater desalination system for comprehensive utilization of marine energy according to some embodiments of the present disclosure; FIG. 2 is a schematic diagram illustrating a structure of an integrated power generation assembly according to some embodiments of the present disclosure; FIG. 3 is a schematic diagram illustrating a structure of a spring water pipe according to some embodiments of the present disclosure; FIG. 4 is a schematic diagram illustrating a structure of a restriction tube according to some embodiments of the present disclosure; FIG. 5 is a schematic diagram illustrating a structure of a filtering mesh according to some embodiments of the present disclosure; FIG. 6 is a schematic diagram illustrating a structure of power fan blades according to some embodiments of the present disclosure; FIG. 7 is a schematic diagram illustrating a structure of a floating ball according to some embodiments of the present disclosure; and FIG. 8 is a schematic diagram illustrating a structure of a heat dissipation plate according to some embodiments of the present disclosure.

In some embodiments, as shown in FIGS. 1-8, the seawater desalination system includes a mounting rod 1, an integrated power generation assembly 2 is mounted on an outer side of the mounting rod 1; the integrated power generation assembly 2 includes a sliding slot 201; the sliding slot 201 is formed throughout a surface of the mounting rod 1, a sliding sleeve 202 is slidably sleeved on the outer side of the mounting rod 1, and a regulating box 203 is welded at a bottom end of the sliding sleeve 202; a front water pipe 208 is connected to one end face of the regulating box 203, and a rear water pipe 211 is connected to the other end face of the regulating box 203; a spring water pipe 204 is mounted on an inside of the mounting rod 1, a connecting pipe 205 is connected to one end of the spring water pipe 204, and the connecting pipe 205 is in communication with an inner cavity of the regulating box 203; an inside of the regulating box 203 is provided with a restriction groove 206, and a restriction tube 207 is welded at a middle position of the inside of the regulating box 203; a fixing block 212 is welded at a top end of the sliding sleeve 202, a fixing rod 213 is welded at one end of the fixing block 212, a generator 214 is welded at one end of the fixing rod 213, power fan blades 215 are connected to a rotating end of the generator 214, and a positioning electromagnet 216 is mounted at a top end of the fixing block 212; a fresh water box 223 is sleeved on the outside of the mounting rod 1, a conversion pump 224 is mounted at a bottom end of the fresh water box 223, a manifold 225 is connected to an output end of the conversion pump 224, the other end of the spring water pipe 204 is connected to an input end of the conversion pump 224, and external air is input into the regulating box 203 through the manifold 225, the spring water pipe 204, and the connecting pipe 205 by the conversion pump 224, or seawater is input into the regulating box 203 through the front water pipe 208 and the rear water pipe 211 by the conversion pump 224, to realize lifting and lowering of the power fan blades 215; and a support rod 311 is welded at a top end of the mounting rod 1, a condensate panel 312 is welded at a top end of the support rod 311, and a solar panel 314 is mounted at a top end of the condensate panel 312.

The top end refers to an end portion of a structure that is in the highest position in the direction of gravity; and the bottom end refers to an end portion of a structure that is in the lowest position in the direction of gravity.

The mounting rod 1 refers to a rod-like structure for supporting a plurality of components (e.g., the integrated power generation assembly 2, etc.) of the seawater desalination system. In some embodiments, the mounting rod 1 is a cylindrical rod, and the mounting rod 1 is internally hollow.

The integrated power generation assembly 2 refers to a component that utilizes tidal energy, wind energy, and solar energy to generate electricity.

In some embodiments, the integrated power generation assembly 2 includes the sliding slot 201, the sliding sleeve 202, the regulating box 203, the spring water pipe 204, the connecting pipe 205, the restriction groove 206, the restriction tube 207, the front water pipe 208, a waterproof solenoid valve 209, the filtering mesh 210, the rear water pipe 211, the fixing block 212, the fixing rod 213, the generator 214, the power fan blades 215, the positioning electromagnet 216, a rotating seat 217, a rotating rod 218, the floating ball 219, a toggle plate 220, a rising pressure switch 221, a falling pressure switch 222, the fresh water box 223, the conversion pump 224, the manifold 225, a battery pack 226, and a plumbing chamber 227.

The sliding slot 201 refers to a groove formed throughout the surface of the mounting rod 1. Throughout-formed may be understood as the sliding slot 201 penetrates a rod wall of the mounting rod 1. In some embodiments, the sliding slot 201 is formed throughout the surface of the mounting rod 1 along an axial direction of the mounting rod 1 to form a slot that leads from an outside of the mounting rod 1 to an inside of the mounting rod 1.

The sliding sleeve 202 refers to a tube sleeved on the outer side of the mounting rod 1. In some embodiments, the sliding sleeve 202 is a circular sleeve, axes of the sliding sleeve 202 and the mounting rod 1 coincide, and a diameter of the sliding sleeve 202 is greater than a diameter of the mounting rod 1 to enable the sliding sleeve 202 to be slidingly sleeved on the outer side of the mounting rod 1.

In some embodiments, the sliding sleeve 202 may slide along the axial direction of the mounting rod 1.

The regulating box 203 is used to regulate an axial position of the sliding sleeve 202 on the mounting rod 1. In some embodiments, the regulating box 203 may be of a plurality of centrally symmetric shapes such as rectangular, cylindrical, etc., to enable a center of gravity of the regulating box 203 to be on an axis of the sliding sleeve 202, and the regulating box 203 is internally hollow.

The spring water pipe 204 refers to a flexible pipe that is capable of undergo axial telescopic deformation. In some embodiments, the spring water pipe 204 may be one of a stainless steel corrugated pipe or a reinforced polyurethane hose.

In some embodiments, a diameter of the spring water pipe 204 is smaller than the diameter of the mounting rod 1 to enable the spring water pipe 204 to be mounted in an inner cavity of the mounting rod 1, the one end of the spring water pipe 204 is connected to the connecting pipe 205, and the other end is connected to the input end of the conversion pump 224.

In some embodiments, the spring water pipe 204 is axially contracted when the sliding sleeve 202 moves upward along the axial direction of the mounting rod 1; and the spring water pipe 204 is axially extended when the sliding sleeve 202 moves downward along the axial direction of the mounting rod 1 to maintain continuity of a water path and/or an air path.

The connecting pipe 205 is used to connect the spring water pipe 204 and the regulating box 203. In some embodiments, one end of the connecting pipe 205 is connected to a top of the regulating box 203, and other end of the connecting pipe 205 passes through a wall of a bottom end of the sliding sleeve 202 to be connected to a bottom of the spring water pipe 204.

In some embodiments, one or more connecting pipes 205 may be provided, and a count of connecting pipes 205 may be set based on actual needs.

The restriction groove 206 is used to restrict a limit position of the sliding sleeve 202 moving axially.

In some embodiments, the restriction groove 206 is a circular groove and an axis of the restriction groove 206 coincides with the axis of the sliding sleeve 202.

In some embodiments, when the restriction groove 206 rests against a bottom end of the mounting rod 1, the restriction groove 206 restricts the limit position of the sliding sleeve 202 moving upward along the axial direction of the mounting rod 1.

The restriction tube 207 is used to enable the sliding sleeve 202 to rotate around the axis of the sliding sleeve 202. In some embodiments, the restriction groove 206 is connected to a bottom end of the restriction tube 207. More descriptions regarding how the restriction tube 207 enables the sliding sleeve 202 to rotate around the axis of the sliding sleeve 202 may be found in related descriptions about a working principle and an operation process of the seawater desalination system.

In some embodiments, the connecting pipe 205 is slidably connected to the mounting rod 1 through the sliding slot 201; and an inner diameter of the restriction groove 206 is equal to an inner diameter of the sliding sleeve 202.

In some embodiments, as shown in FIG. 3, the other end of the connecting pipe 205 passes through the wall of the bottom end of the sliding sleeve 202 to snap into the sliding slot 201 to connect to the bottom of the spring water pipe 204, so that the connecting pipe 205 may move with the sliding sleeve 202 along the axial direction of the mounting rod 1.

In some embodiments, the inner diameter of the restriction groove 206 may also be larger or smaller than the inner diameter of the sliding sleeve 202, as long as the restriction groove 206 is capable of accommodating the bottom end of the mounting rod 1.

In some embodiments of the present disclosure, the connecting pipe is slidably connected to the mounting rod through the sliding slot, which can ensure that the conveyance of the seawater is not affected when the sliding sleeve moves along the axial direction of the mounting rod; and the inner diameter of the restriction groove is equal to the inner diameter of the sliding sleeve, which can enable the bottom end of the mounting rod 1 to rest against the restriction groove when the sliding sleeve moves axially upward, so as to restrict the limit position of the sliding sleeve moving axially.

The front water pipe 208 and the rear water pipe 211 refer to water pipes used to input seawater into the inner cavity of the regulating box 203. The front water pipe 208 and the rear water pipe 211 are provided on two end faces of the regulating box 203. An end face refers to a face parallel to a thickness direction of the regulating box 203. In some embodiments, the front water pipe 208 and the rear water pipe 211 may be disposed at positions such as the middle or the side, etc., of the two end faces of the regulating box 203.

In some embodiments, one or more front water pipes 208 and one or more rear water pipes 211 may be provided, and the one or more of the front water pipes 208 and one or more the rear water pipes 211 are evenly distributed on end faces of the regulating box 203 to ensure that the center of gravity of the regulating box 203 is on the axis of the sliding sleeve 202, thus preventing the sliding sleeve 202 from deviating during sliding along the axial direction of the mounting rod 1, which may result in unevenly sliding or being stuck.

Merely by way of example, as shown in FIG. 4, a front water pipe 208 is connected to a side of one end face of the regulating box 203, and a rear water pipe 211 may be connected to a side of other end face of the regulating box 203.

In some embodiments, the front water pipe 208 and the rear water pipe 211 may feed the seawater into or discharge seawater from the inner cavity of the regulating box 203 to regulate a weight of the regulating box 203, thereby regulating the axial position of the sliding sleeve 202 on the mounting rod 1. More descriptions regarding the section may be found in related descriptions about the working principle and the operation process of the seawater desalination system.

In some embodiments, the waterproof solenoid valve 209 is mounted on an outer side of the front water pipe 208, and the filtering mesh 208 is snap-fitted at an end of the front water pipe 208.

In some embodiments, similarly to the front water pipe 208, a waterproof solenoid valve is also mounted on an outer side of the rear water pipe 211, and a filtering mesh is also snap-fitted to one end of the rear water pipe 211.

The waterproof solenoid valve 209 is used to control opening and closing of the front water pipe 208. For example, the waterproof solenoid valve 209 may be one of a pilot-operated high pressure solenoid valve, a direct-acting solenoid valve, etc. In some embodiments, the waterproof solenoid valve 209 is disposed on a side of the front water pipe 208 close to the regulating box 203.

The filtering mesh 210 is used to filter impurities in the seawater. In some embodiments, the filtering mesh 210 is snap-fitted to an end of the front water pipe 208 away from the regulating box 203.

In some embodiments of the present disclosure, the pathway for the seawater to enter into/discharge from the regulating box can be opened/closed quickly by providing the waterproof solenoid valve; and by snap-fitting the filtering mesh to the front water pipe, it is not only able to filter the impurities in the seawater, but also facilitates to replace the filtering mesh in a later period of time.

The fixing block 212 is used to fix the fixing rod 213. The fixing rod 213 is used to fix the generator 214.

In some embodiments, the fixing block 212 may be of a plurality of shapes. For example, the fixing block 212 may be of a sphere, a rectangle, or other polygon, and a center of gravity of the fixing block 212 is on the axis of the mounting rod 1.

In some embodiments, the sliding sleeve 202 is welded at a bottom end of the fixing block 212, and the fixing block 212 is provided with an opening throughout from a top end to a bottom end of the fixing block 212, and a shape and a size of the opening match the diameter of the mounting rod 1 to enable the sliding sleeve 202 to smoothly move or rotate along the axial direction of the mounting rod 1.

In some embodiments, a plurality of fixing rods 213 may be provided on end faces of the fixing block 212, and the plurality of fixing rods 213 is evenly distributed along a circumferential direction of the mounting rod 1 to ensure uniform force bearing of the fixing block 212. One end of the fixing rod 213 is connected to the end face of the fixing block 212 by welding, bolting, etc., and other end of the fixing rod 213 is connected to the generator 214 by welding, bolting, etc.

In some embodiments, as shown in FIG. 6, a count of the fixing rod 213 is two, and two fixing rods 213 are symmetrically mounted on end surfaces of both sides of the fixing block 212, so as to enable the fixing block 212 to be subjected to symmetrical and stable force.

In some embodiments of the present disclosure, symmetrically arrangement of the fixing rods facilitates the installation of generators, which is conductive to the overall stability of the seawater desalination system.

In some embodiments, one end of the fixing rod 213 is connected to an end face of the fixing block 212, and other end of the fixing rod 213 is connected to the generator 214.

The generator 214 is used to convert kinetic energy of the generator 214 into electrical energy. In some embodiments, the power fan blades 215 are fixedly connected to the rotating end of the generator 214 (e.g., a rotor of the generator 214).

The power fan blades 215 are used to convert the tidal energy and the wind energy into the kinetic energy of the generator 214. In some embodiments, the power fan blades 215 may rotate under the influence of tidal changes and wind force, so as to drive the rotating end of the generator 214 to rotate.

In some embodiments, as shown in FIG. 7, the rotating seat 217 is welded on an end face of the fixing block 212, and the rotating rod 218 is rotationally mounted on an inside of the rotating seat 217, and the floating ball 219 is connected to one end of the rotating rod 218, and the toggle plate 220 is welded at the other end of the rotating rod 218; and the rising pressure switch 221 is mounted on one end face of the fixing block 212, and the falling pressure switch 222 is mounted on the other end face of the fixing block 212 at a position symmetrical to the rising pressure switch 221.

The rotating seat 217 refers to a structure welded to an end face of the fixing block 212 facing the seawater. The rotating rod 218 may be rotatably connected to the rotating seat 217. For example, the rotating rod 218 is connected to the rotating seat 217 by a pin. The floating ball 219 refers to a sealed ball that is hollow inside and capable of floating on the surface of the sea.

In some embodiments, the one end of the rotating rod 218 is connected to an end face of the floating ball 219 by snap-fitting, bolting, etc., and the other end of the rotating rod 218 is welded at a middle of the toggle plate 220.

The toggle plate 220 presses the rising pressure switch 221 or the falling pressure switch 222. In some embodiments, a lengthwise direction of the toggle plate 220 is perpendicular to a lengthwise direction of the rotating rod 218.

The rising pressure switch 221 refers to a switch for controlling inputting of air into the inner cavity of the regulating box 203. The falling pressure switch 222 refers to a switch for controlling inputting of the seawater into the inner cavity of the regulating box 203.

The “symmetrical position” may be understood as the rising pressure switch 221 is mounted at an uppermost portion of the end face of the toggle plate 220 close to the floating ball 219, and the falling pressure switch 222 is mounted at a lowermost portion of the end face of the toggle plate 220 close to the floating ball 219.

In some embodiments, when a sea level rises during tide rising, the floating ball 219 moves upward with the sea level to drive the rotating rod 218 to rotate in a direction close to the rising pressure switch 221, the toggle plate 220 rotates synchronously and an upper portion of the toggle plate 220 presses the rising pressure switch 221, and air is input into the inner cavity of the regulating box 203 to generate buoyancy to drive the regulating box 203 to move upward, thereby driving the sliding sleeve 202 to move upward along the axial direction of the mounting rod 1. When the sea level drops during tide falling, the floating ball 219 moves downward with the sea level to drive the rotating rod 218 to rotate in a direction close to the falling pressure switch 222, the toggle plate 220 rotates synchronously and a lower portion of the toggle plate 220 presses the falling pressure switch 222, and the seawater is input into the inner cavity of the regulating box 203 to increase gravity of the regulating box 203, thereby driving the sliding sleeve 202 to move downward along the axial direction of the mounting rod 1.

During the axial movement of the sliding sleeve 202, the seawater flows to drive the power fan blades 215 to rotate, which enables the generator 214 to generate the electrical energy.

The positioning electromagnet 216 is used to fix the axial position of the sliding sleeve 202 on the mounting rod 1. In some embodiments, the positioning electromagnet 216 is mounted to the top end of the fixing block 212 by welding, snap-fitting, or other mounting components, as shown in FIG. 7. The positioning electromagnet 216 is circular in shape, and the axis of the positioning electromagnet 216 coincides with the axis of the mounting rod 1, and the diameter of the positioning electromagnet 216 is larger than the diameter of the mounting rod 1 to allow the sliding sleeve 202 to move smoothly along the axial direction of the mounting rod 1.

In some embodiments, when the positioning electromagnet 216 is energized, the sliding sleeve 202 no longer moves along the axial direction of the mounting rod 1, and the axial position of the sliding sleeve 202 is fixed. When the positioning electromagnet 216 is de-energized, the sliding sleeve 202 may move smoothly along the axial position of the mounting rod 1.

The fresh water box 223 is used to collect and store condensed fresh water. In some embodiments, the fresh water box 223 is sleeved on an outer side of the top end of the mounting rod 1.

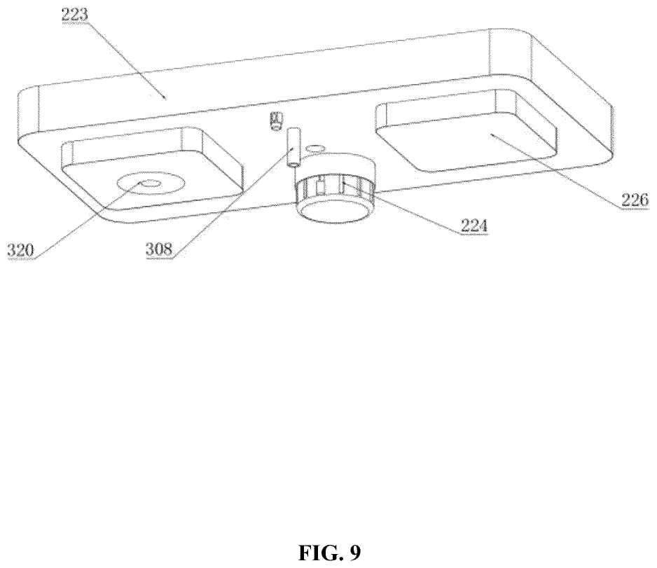

FIG. 9 is a schematic diagram illustrating a structure of a bottom end of a fresh water box according to some embodiments of the present disclosure.

In some embodiments, as shown in FIG. 2 and FIG. 9, the battery pack 226 is mounted at the bottom end of the fresh water box 223, and the plumbing chamber 227 is provided on the inside of the mounting rod 1.

The battery pack 226 is used to store the electrical energy converted by the generator 214. In some embodiments, as shown in FIG. 9, a first accommodation space is provided on one side of the bottom end of the fresh water box 223, and the battery pack 226 is disposed in the first accommodation space.

The plumbing chamber 227 refers to an inner cavity of the mounting rod 1. In some embodiments, the plumbing chamber 227 is used to accommodate and protect the spring water pipe 204.

In some embodiments of the present disclosure, the battery pack can store the electrical energy converted by the generator for subsequent use to improve the energy utilization efficiency, and the plumbing chamber can protect the spring water pipe and prevent the spring water pipe from being damaged.

In some embodiments, the restriction tube 207 is welded to at a position on the inside of the regulating box 203 corresponding to the restriction groove 206; and an output end of the generator 214 is connected to an input end of the battery pack 226, and a contact surface of the sliding sleeve 202 and a contact surface of the mounting rod 1 are both smooth surfaces.

The restriction tube 207 being welded to the position of the inside of the regulating box 203 corresponding to the restriction groove 206 may be understood as follows: a bottom end of the restriction tube 207 being mounted at a position where the restriction groove 206 is provided, and an axis of the restriction tube 207 coinciding with an axis of the restriction groove 206.

In some embodiments, the output end of the generator 214 is connected to the input end of the battery pack 226 by a wire, thereby realizing electrical connection.

In some embodiments of the present disclosure, the restriction tube facilitates the lifting and lowering of the sliding sleeve; the electrical energy of the generator can be stored in the battery pack for subsequent use; and the provision of the smooth surfaces facilitates the smooth movement of the sliding sleeve with respect to the mounting rod.

The conversion pump 224 is used to convert a medium (e.g., the seawater or the external air) input into the inner cavity of the regulating box 3. In some embodiments, as shown in FIG. 3 and FIG. 9, the conversion pump 224 is provided at the bottom end of the fresh water box 223.

The manifold 225 is used to deliver the seawater or the external air. In some embodiments, the manifold 225 includes at least two ports, one port of the manifold 225 is connected to the output of the conversion pump 224 (e.g., an impeller end of the conversion pump 224, etc.), and other port of the manifold 225 is connected to outside.

Merely by way of example, as shown in FIG. 3, the manifold 225 is of “T” shape and includes three ports, one port of the three ports is connected to the conversion pump 224, and two ports of the three ports are connected to the outside.

In some embodiments, when the rising pressure switch 221 is pressed, the conversion pump 204 operates to enable the external air to be input into the inner cavity of the conversion pump 203 via the manifold 225, the spring water pipe 204, and the connecting pipe 205. When the lower rising pressure switch 222 is pressed, the conversion pump 204 operates to enable the seawater to be input into the inner cavity of the regulating box 203 via the front water pipe 208 and the rear water pipe 211.

The support rod 311 is used to carry the condensate panel 312 and the solar panel 314. In some embodiments, one end of the support rod 311 passes through the fresh water box 223 and is welded to the top end of the mounting rod 1, and the other end of the support rod 311 is welded to the bottom end of the condensate panel 312.

The condensate panel 312 is used to condense water vapor. In some embodiments, the condensate panel 312 may be mounted on a top of the fresh water box 223 by bolting, welding, etc.

The solar panel 314 is used to convert the solar energy into the electrical energy. In some embodiments, the solar panel 314 is mounted at the top end of the condensate panel 312.

In some of the embodiments of the present disclosure, the seawater desalination system has a simple structure, which is safe and convenient to use, and the power fan blades rotate to drive the generator to generate electricity. The fixed block can be rotated at any time according to the meteorological information to ensure that the generator is always in an efficient power generation state. In summary, the seawater desalination system can reduce the impact of marine meteorological conditions on desalination, and comprehensively utilize the solar energy, the wind energy, and the tidal energy to desalinate the seawater, which ensures that the seawater desalination is always in a highly efficient state to guarantee the living water of the personnel in distant sea, further enhancing the stability of the seawater desalination.

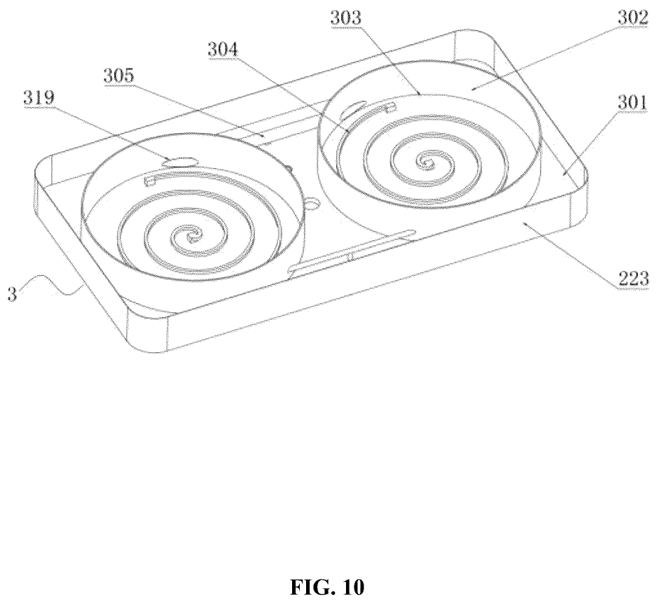

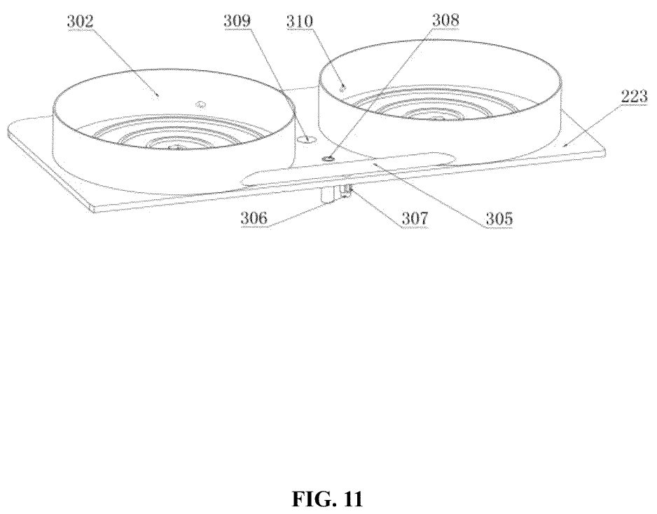

FIG. 10 is a schematic diagram illustrating a structure of an evaporation assembly according to some embodiments of the present disclosure; and FIG. 11 is a schematic diagram illustrating a structure of a wastewater connecting pipe according to some embodiments of the present disclosure.

In some embodiments, as shown in FIG. 1 and FIGS. 8-11, an evaporation assembly 3 is mounted at a top end of the fresh water box 223; the evaporation assembly 3 includes a fresh water chamber 301; the fresh water chamber 301 is provided at the top end of the fresh water box 223, at least one evaporation cell 302 is mounted on an inside of the fresh water chamber 301, a seawater chamber 303 is provided on an inside of each of the at least one evaporation cell 302, heating resistance wires 304 are mounted on an inner side of the seawater chamber 303, an outer side of each of the at least one evaporation cell 302 is connected with a wastewater connecting pipe 305, a wastewater discharge pipe 306 is welded at a bottom position of an outside of the wastewater connecting pipe 305, and a wastewater solenoid valve 307 is sleeved on an outside of the wastewater discharge pipe 306; a fresh water pipe 308 is connected to the bottom end of the fresh water box 223, a snap-in groove 309 is provided at a middle position of the bottom end of the fresh water box 223, and a water inlet hole 310 is provided on the inside of each of the at least one evaporation cell 302; a deflector groove plate 313 is welded at a bottom end of the condensate panel 312, a heat dissipation plate 315 is mounted at the side of the top end of the condensate panel 312 close to the solar panel 314, an outer side of the fresh water box 223 is welded with a connecting bracket 316, an end of the connecting bracket 316 is welded with a mounting bracket 317, and a condensate slot 318 is provided at the bottom end of the condensate panel 312; and a waste water tank 319 is provided at a connection position between the inside of each of the at least one evaporation cell 302 and the wastewater connecting pipe 305, and a controller 320 is mounted on the bottom end of the fresh water box 223.

The evaporation assembly 3 refers to an assembly that converts seawater into fresh water utilizing a distillation technology.

In some embodiments, the evaporation assembly 3 includes the fresh water chamber 301, the at least one evaporation cells 302, the seawater chamber 303, the heating resistance wires 304, the wastewater connecting pipe 305, the wastewater discharge pipe 306, the wastewater solenoid valve 307, the fresh water pipe 308, the snap-in groove 309, the water inlet hole 310, the support rod 311, the condensate panel 312, the deflector groove plate 313, the solar panel 314, the heat dissipation plate 315, the connecting bracket 316, the mounting bracket 317, the condensate slot 318, the waste water tank 319, and the controller 320. More descriptions regarding the support rod 311, the condensate panel 312, and the solar panel 314 may be found in FIGS. 1-8 and related descriptions thereof.

The fresh water chamber 301 refers to a chamber for collecting and storing the fresh water obtained by distillation. In some embodiments, the fresh water chamber 301 is provided in an inner cavity of the fresh water box 223, and the fresh water chamber 301 may be integrally molded or spliced with the fresh water box 223. In some embodiments, one or more evaporation cells 302 are provided at a bottom of the inner side of the fresh water chamber 301, and a count of the evaporation cells 302 and an arrangement of the evaporation cells 302 are set based on actual needs.

The evaporation cell 302 is used to evaporate the seawater. In some embodiments, the inside of the each of the at least one evaporation cell 302 is the seawater chamber 303.

The seawater chamber 303 refers to a chamber for storing seawater to be evaporated. In some embodiments, the helically coiled heating resistance wires 304 are mounted at a bottom of the inner side of the seawater chamber 303. The heating resistance wires 304 are used to heat and vaporize the seawater.

The wastewater connecting pipe 305 is used to direct wastewater to the wastewater discharge pipe 306. The wastewater discharge pipe 306 is used to discharge the wastewater out of the seawater desalination system.

In some embodiments, the wastewater connecting pipes 305 may have a plurality of ports one port of the plurality of ports of the wastewater connecting pipe 305 is connected to the wastewater discharge pipe 306, other ports of the plurality of ports of the wastewater connecting pipe 305 are connected to each other and connected to a sidewall of an evaporation cell 302, and other end of the wastewater discharge pipe 306 is connected to outside (e.g., the ocean, an external wastewater pond, etc.).

In some embodiments, as shown in FIG. 10, two evaporation cells 302 are mounted, the two evaporation cells 302 are symmetrically mounted on the inside of the fresh water box 223, and two ends of the wastewater connecting pipes 305 are connected to the two evaporation cells 302, respectively.

The “symmetrically mounted” may be understood as the two evaporation cells 302 are symmetrically provided on both sides of the inner cavity of the fresh water box 223.

Merely by way of example, as shown in FIG. 10, the two ends of the wastewater connecting pipe 305 are connected to the sidewalls of the two evaporation cells 302, respectively, and the wastewater discharge pipe 306 is connected to a middle of the wastewater connecting pipe 305 and is connected to the wastewater connecting pipe 305.

The wastewater solenoid valve 307 is used to open and close the wastewater discharge pipe 306.

In some embodiments, when the seawater in the at least one evaporation cell 302 reaches a preset condition, the wastewater solenoid valve 307 opens and the wastewater is discharged from the wastewater discharge pipe 306. When the wastewater is discharged, the wastewater solenoid valve 307 is closed.

The preset condition may include at least one of a concentration of the seawater in the at least one evaporation cell 302 reaching a concentration threshold, a water-salt ratio reaching a ratio threshold, etc. The concentration of the wastewater may be obtained by a concentration meter set in the at least one evaporation cell 302, the water-salt ratio may be obtained by a sensor (e.g., a conductivity sensor, etc.) set in the at least one evaporation cell 302, and the concentration threshold and the ratio threshold are set based on experience.

The fresh water pipe 308 is used to direct the fresh water from the fresh water chamber 301 to a water storage facility. In some embodiments, one end of the fresh water pipe 308 is connected to a bottom wall of the fresh water chamber 301, and other end of the fresh water pipe 308 is connected to the water storage facility.

The snap-in groove 309 is used to snap-in the support rod 311.

The water inlet hole 310 is used to deliver the seawater to be evaporated into the at least one evaporation cell 302. In some embodiments, the water inlet hole 310 is provided in a sidewall of the each of the at least one evaporation cell 302, and the position of the water inlet hole 310 is higher than that of the wastewater connecting pipe 305. In some embodiments, one end of the water inlet hole 310 is connected to the manifold 225, and the conversion pump 224 may input the seawater into the each of the at least one evaporation cell 302 via the front water pipe 208 and the rear water pipe 211, the connecting pipe 205, the spring water pipe 204, the manifold 225, and the water inlet hole 310.

The deflector groove plate 313 is used to deflect water droplets on a surface of the condensate panel 312 into the fresh water chamber 301. In some embodiments, the deflector groove plate 313 is provided on a bottom surface of the condensate panel 312 facing toward the fresh water box 223.

The heat dissipation plate 315 is used to increase a heat dissipation area to reduce a temperature of the condensate panel 312. In some embodiments, the heat dissipation plate 315 is a fin-like shape and forms an angle with the surface of the condensate panel 312. In some embodiments, a plurality of heat dissipation plates 315 are mounted on a bottom surface of the condensate panel 312 facing toward the solar panel 314.

The connecting bracket 316 is used to connect the mounting bracket 317 to the fresh water box 223. In some embodiments, one end of the connecting bracket 316 is connected to an end face of the fresh water box 223 by welding, and other end of the connecting bracket 316 is connected to a bracket of the mounting bracket 317 by welding.

In some embodiments, a plurality of connecting brackets 316 may be provided. Merely by way of example, as shown in FIG. 1, two connecting brackets 316 are provided, and the two connecting brackets 316 are mounted on opposite end surfaces of the fresh water box 223 (i.e., symmetrically mounted around the axis of the mounting rod 1).

The mounting bracket 317 is used to fix the entire seawater desalination system to an external fixed structure. The external fixed structure may be an offshore platform, a circulation place of a bay dam, etc. For example, the technician may fix a bracket of the mounting bracket 317 to the external fixed structure.

The condensate slot 318 is used to guide the condensed fresh water from the condensate panel 312 into the fresh water chamber 301. In some embodiments, the condensate panel 312 is provided with one or more condensate slots 318 on a face facing toward a bottom of the fresh water box 223. When water vapor condenses on the condensate panel 312, the water droplets may flow down into the fresh water chamber 301 along the one or more condensate slots 318.

The waste water tank 319 is used to temporarily store the wastewater during the process of distillation. In some embodiments, the waste water tank 319 is provided at a connection position between a side wall of the each of the at least one evaporation cell 302 and the wastewater connecting pipe 305.

The controller 320 is used to process a plurality of data and commands during working process of the seawater desalination system and control starting and closing of a plurality of components (e.g., the waterproof solenoid valve 209, the positioning electromagnet 226, the conversion pump 224, the heating resistance wires 304, the wastewater solenoid valve 307, etc.) of the seawater desalination system.

In some embodiments, the controller 320 may be communicatively connected with a remote server to obtain wind direction information, meteorological information, etc.

In some embodiments, a work program of the seawater desalination system is stored in the controller 320. The controller 320 may include one or a combination of programmable controller (PLC), central processing unit (CPU), microcontroller unit (MCU), etc.

In some embodiments, as shown in FIG. 9, a second accommodation space is provided on one side of the bottom end of the fresh water box 223, and the controller 320 is disposed in the second accommodation space.

In some embodiments, the waterproof solenoid valve 209, the positioning electromagnet 216, the rising pressure switch 221, the falling pressure switch 222, the conversion pump 224, input ends of the heating resistance wires 304, and an input end of the solar panel 314 are electrically connected to an output end of the controller 320, and an input end of the controller 320 is electrically connected to an output end of the battery pack 226.

In some embodiments, the waterproof solenoid valve 209, the positioning electromagnet 216, the rising pressure switch 221, the falling pressure switch 222, the conversion pump 224, input ends of the heating resistance wires 304, and an input end of the solar panel 314 are connected to an output end of the controller 320 by wires, thereby realizing electrical connection, and an input end of the controller 320 is connected to an output end of the battery pack 226 by a wire, thereby realizing electrical connection.

In some embodiments of the present disclosure, electrical connection between components can ensure a continuous power supply to transmit the plurality of data and commands during the operation of the seawater desalination system, so as to maintain the normal operation of the seawater desalination system.

It is worth stating that, since the seawater desalination system is applied in a marine environment, the plurality of components in the seawater desalination system may be made of high-strength and corrosion-resistant materials. For example, the materials may be one or a combination of stainless steel, alloy, ceramic, composite material, etc. Surfaces of the plurality of components may also be coated with a coating to further increase the corrosion resistance of the plurality of components to extend service lives of the plurality of components.

In some embodiments, the plurality of components may be connected to each other utilizing any connection method (e.g., bolting, snap-fitting, etc.) that achieves the desired requirement, in addition to utilizing welding for the connection. It is understood that sealing materials may also be filled a gap between adjacent components to achieve sealing.

In some embodiments, taking the seawater desalination system of FIGS. 1-11 as an example, a working principle and a utilizing process of the seawater desalination system of the present disclosure is described as follows: an operator first mounts the seawater desalination system to the external fixed structure by the connecting bracket 316 and the mounting bracket 317.

The seawater desalination system may utilize the tidal energy when the ocean condition is in a period of active tidal activity. At this time, the controller 320 may control the conversion pump 224 to start, and open the waterproof solenoid valve 209 on the outside of the front water pipe 208 and the rear water pipe 211 at the same time; the seawater enters into the inner cavity of the regulating box 203 after being filtered by the filtering mesh 210 to increase the weight of the regulating box 203; the regulating box 203 drives the sliding sleeve 202 to move downward along the outside of the mounting rod 1 (i.e., toward the deep sea), thereby driving the fixing block 212 to move downward; and if the rising pressure switch 221 and the falling pressure switch 222 are not triggered, it indicates that the floating ball 219 is located at the sea level at this time, and the controller 320 subsequently closes the conversion pump 224.

At this time, the controller 320 controls to start the positioning electromagnet 216 (i.e., energize the power into the positioning electromagnet 216), the positioning electromagnet 216 fixes the sliding sleeve 202 at the outside of the mounting rod 1, the sliding sleeve 202 no longer moves axially, the fixing block 212 is fixed at the sea level, and the generators 214 connected to the two fixing rods 213 and the power fan blades 215 are located at the at the sea level. If the tide occurs at this time (tide rising or tide falling), the seawater may continuously flow at positions where the power fan blades 215 are located to drive the power fan blades 215 to rotate; since the power fan blades 215 are fixedly connected to rotating ends of the generators 214, the rotating ends of the generators 214 rotate synchronously to continuously generate electrical energy; and the electrical energy generated by the generators is inputted through wires to store in the battery pack 226.

The electrical energy converted from the tidal energy may be used to distill the seawater for seawater desalination. During the use of the seawater desalination system, the sea level changes constantly due to tide changes. When the sea level rises during tide rising, the floating ball 219 moves upward with the sea level to drive the rotating rod 218 to rotate in a direction close to the rising pressure switch 221, and the toggle plate 220 rotates synchronously and an upper portion of the toggle plate 220 presses the rising pressure switch 221; in response to determining that the controller 320 receives a signal that the rising pressure switch 221 is pressed, the controller controls the conversion pump 224 to start to enable the external air to being input into the inner cavity of the regulating box 203 via the manifold 225, the spring water pipe 204, and the connecting pipe 205; and the controller 320 closes the two waterproof solenoid valves 209, and the air in the inner cavity of the regulating box 203 generates buoyancy to drive the regulating box 203 to move upward, thereby driving the sliding sleeve 202 and the power fan blades 215 to move upward to the sea level. When the floating ball 219 floats at the sea level again, the rising pressure switch 221 stops being pressed, and at this time, the controller 320 controls the positioning electromagnet 216 to start to fix the generators 214 and the power fan blades 215.

During the above-described process of tide rising, the continuously flowing tide may drive the power fan blades 215 to rotate, thereby driving the generators 214 to generate the electrical energy. For every first preset height of tide rising, the controller 320 controls the sliding sleeve 202 to move upward once to enable the power fan blades 215 to be always at the sea level. The first preset height is set based on experience.

When the sea level drops during tide falling, the floating ball 219 loses the support of the seawater to move downward and drive the rotating rod 218 to rotate in a direction close to the falling pressure switch 222, and the toggle plate 220 rotates synchronously and a lower portion of the toggle plate 220 presses the falling pressure switch 222; in response to determining that the controller 320 receives a signal that the falling pressure switch 222 is pressed, the controller 320 controls the conversion pump 224 to start and re-pump the seawater into the inner cavity of the regulating box 203 to increase the weight of the regulating box 203 to drive the regulating box 203 to move downward, thereby driving the sliding sleeve 202 and the power fan blades 215 to move downward to the sea level. When the floating ball 219 floats at the sea level again, the falling pressure switch 222 stops being pressed, and at this time, the controller 320 controls the positioning electromagnet 216 to start to fix the generators 214 and the power fan blades 215.

During the above-described process of tide falling, the falling tide may drive the power fan blades 215 to rotate again, thereby driving the generators 214 to generate the electrical energy. For every second preset height of the tide falling, the controller 320 controls the sliding sleeve 202 to move downward once to enable the power fan blades 215 to be always at the sea level. The second preset height is set based on experience.

During the above-described process of tide rising and tide falling, the seawater desalination system may utilize the rise and fall of tides to continuously generate the electrical energy to provide the electrical energy for desalinated seawater.

When the tidal activity is inactive but the wind is active, the controller 320 may control the conversion pump 224 to input the external air into the inner cavity of the regulating box 203, and close the two waterproof solenoid valves 209 at the same time; and at that time, the regulating box 203 floats at the sea level under the driving of the air in the inner cavity of the regulating box 203 to push the generators 214 and the power fan blades 215 to above the sea level; the controller 320 may obtain the wind direction information released by a local weather station and control the starting or stopping of the conversion pump 224 or the waterproof solenoid valve 209 on the outside of the front water pipe 208 based on the wind direction information. When the sea wind blows to the sea level, the sea wind may push the regulating box 203 to rotate on the outside of the mounting rod 1 through the restriction tube 207, and then the fixing block 212 may be driven to rotate by the sliding sleeve 202, thereby rotating the generator 214 and the power fan blades 215 to a position toward the sea wind; and at this time, the controller 320 closes the waterproof solenoid valve 209 on the outside of the front water pipe 208, thereby stopping the rotation of the fixing block 212. The sea wind drives the power fan blades 215 to rotate, thereby driving the generator 214 to generate electricity.

During the above process, the controller 320 obtains the meteorological information in real time or at a regular interval and rotates the fixing block 212 based on the meteorological information to enable the generators 214 to be always in a state of high efficiency in generating the electrical energy.

When both wind and tide are inactive, the solar panels 314 may continuously convert the solar energy into the electrical energy and input the electrical energy into the battery pack 226 for storing.

The electrical energy stored in the battery pack 226 is continually utilized for seawater distillation to enable the seawater desalination system to continually produce the fresh water.

When the ocean conditions are in a monsoon period, the controller 320 controls the conversion pump 224 to input the external air into the inner cavity of the regulating box 203 and closes the two waterproof solenoid valves 209 at the same time, thereby pushing the generators 214 and the power fan blades 215 to the sea level; the fixing block 212 is rotated to face toward the wind direction, the generators 214 and the power fan blades 215 face toward the sea wind at this time, the sea wind may blow the power fan blades 215 to rotate at this time to drive the generators 214 to generate the electrical energy; and the controller 320 may rotate the fixing block 212 in real time or at a regular interval based on the meteorological information, so as to enable the generators 214 to be always in the state of highly efficient in generating the electrical energy.

The seawater desalination system can reduce the impact of marine meteorology on desalination, which can ensure that the desalination is always in the highly efficient state, guarantee the living water of the personnel in distant sea, and further enhance the stability of seawater desalination.

The conversion pump can quickly change the amount of the seawater in the regulating box, and the positions of the generators and the positions of the power fan blades can be quickly changed under the driving of the regulating box to enable the generators and the power fan blades to move quickly to different power generation positions for utilizing different natural resources, which enables the seawater desalination device to fully utilize the natural resources for seawater desalination and improves the efficiency of seawater desalination.

In some embodiments, the seawater is input into the seawater chambers 303 inside of the two evaporation cells 302 through the manifold 225; the controller 320 controls the heating resistance wires 304 to start, and the heating resistance wires 304 rapidly heat the seawater in the seawater chamber 303 to generate water vapor; the water vapor rises to contact the condensate panel 312 for condensing and liquefying; the wind from the surface of the sea continuously blows the heat dissipation plate 315 to enable the condensate panel 312 to be cooled rapidly, which further enhances the efficiency of the condensation and liquefaction; the condensed and liquefied fresh water flows downward along the inner wall of the condensate slot 318; and when the fresh water contacts to the deflector groove plate 313, the fresh water drops down into the fresh water chamber 301 and flows into the external water storage facility through the fresh water pipe 308 connected to the bottom of the fresh water chamber 301.

During the process of evaporating the seawater in the two evaporation cells 302, the amount of the seawater in the two evaporation cells 302 decreases, which results in a formation of a liquid mixture of water and salt. When the seawater in the two evaporation cells 302 reaches a preset condition (e.g., a weight ratio of water to salt of 3:7), the controller 320 controls the heating resistance wires 304 to stop heating the seawater and starts the wastewater solenoid valve 307 at the same time to enable the liquid mixture to be discharged into the sea by the wastewater discharge pipe 306.

In the embodiment of the present disclosure, timely discharging the wastewater can prevent the salt in the seawater from crystallizing and solidifying, thereby preventing the sea salt from corroding and clogging the internal pipes of the seawater desalination system and guaranteeing the seawater desalination efficiency while prolonging the service life of the seawater desalination system. In addition, the wind on the surface of the sea can constantly blow the heat dissipation plate 315 to rapidly cool the condensate panel 312, further enhancing the seawater desalination efficiency.

The basic concepts have been described above, and it is apparent to a person skilled in the art that the above detailed disclosure is merely exemplary and does not constitute a limitation of the present disclosure. While not expressly stated herein, various modifications, improvements, and amendments may be made to the present disclosure by those skilled in the art. Those modifications, improvements, and amendments are suggested in the present disclosure, so those modifications, improvements, and amendments remain within the spirit and scope of the exemplary embodiments of the present disclosure.

Finally, it should be understood that the embodiments described in the present disclosure are used only to illustrate the principles of the exemplary embodiments of the present disclosure. Other deformations may also fall within the scope of this disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A seawater desalination system for comprehensive utilization of marine energy, comprising a mounting rod, an integrated power generation assembly being mounted on an outer side of the mounting rod;
the integrated power generation assembly including a sliding slot; wherein
the sliding slot is formed throughout a surface of the mounting rod, a sliding sleeve is slidably sleeved on the outer side of the mounting rod, and a regulating box is welded at a bottom end of the sliding sleeve;
a front water pipe is connected to one end face of the regulating box, and a rear water pipe is connected to the other end face of the regulating box;
a spring water pipe is mounted on an inside of the mounting rod, a connecting pipe is connected to one end of the spring water pipe, and the connecting pipe is in communication with an inner cavity of the regulating box;
an inside of the regulating box is provided with a restriction groove, and a restriction tube is welded at a middle position of the inside of the regulating box;
a fixing block is welded at a top end of the sliding sleeve, a fixing rod is welded at one end of the fixing block, a generator is welded at one end of the fixing rod, power fan blades are connected to a rotating end of the generator, and a positioning electromagnet is mounted at a top end of the fixing block;
a fresh water box is sleeved on an outside of the mounting rod, a conversion pump is mounted at a bottom end of the fresh water box, a manifold is connected to an output end of the conversion pump, the other end of the spring water pipe is connected to an input end of the conversion pump, and external air is input into the regulating box through the manifold, the spring water pipe, and the connecting pipe by the conversion pump, or seawater is input into the regulating box through the front water pipe and the rear water pipe by the conversion pump, to realize lifting and lowering of the power fan blades; and
a support rod is welded at a top end of the mounting rod, a condensate panel is welded at a top end of the support rod, and a solar panel is mounted at a top end of the condensate panel.

2. The seawater desalination system for comprehensive utilization of marine energy according to claim 1, wherein a battery pack is mounted at the bottom end of the fresh water box, and a plumbing chamber is provided on the inside of the mounting rod.

3. The seawater desalination system for comprehensive utilization of marine energy according to claim 2, wherein a waterproof solenoid valve is mounted on an outer side of the front water pipe, and a filtering mesh is snap-fitted at an end of the front water pipe.

4. The seawater desalination system for comprehensive utilization of marine energy according to claim 1, wherein a count of the fixing rod is two, and two fixing rods are symmetrically mounted on end surfaces of both sides of the fixing block.

5. The seawater desalination system for comprehensive utilization of marine energy according to claim 3, wherein a rotating seat is welded on an end face of the fixing block, and a rotating rod is rotationally mounted on an inside of the rotating seat, and a floating ball is connected to one end of the rotating rod, and a toggle plate is welded at the other end of the rotating rod; and
a rising pressure switch is mounted on one end face of the fixing block, and a falling pressure switch is mounted on the other end face of the fixing block at a position symmetrical to the rising pressure switch.

6. The seawater desalination system for comprehensive utilization of marine energy according to claim 1, wherein the connecting pipe is slidably connected to the mounting rod through the sliding slot; and
an inner diameter of the restriction groove is equal to an inner diameter of the sliding sleeve.

7. The seawater desalination system for comprehensive utilization of marine energy according to claim 5, wherein the restriction tube is welded to at a position on the inside of the regulating box corresponding to the restriction groove; and
an output end of the generator is connected to an input end of the battery pack, and a contact surface of the sliding sleeve and a contact surface of the mounting rod are both smooth surfaces.

8. The seawater desalination system for comprehensive utilization of marine energy according to claim 7, wherein an evaporation assembly is mounted at a top end of the fresh water box;
the evaporation assembly includes a fresh water chamber;
the fresh water chamber is provided at the top end of the fresh water box, at least one evaporation cell is mounted on an inside of the fresh water chamber, a seawater chamber is provided on an inside of each of the at least one evaporation cell, heating resistance wires are mounted on an inner side of the seawater chamber, an outer side of each of the at least one evaporation cell is connected with a wastewater connecting pipe, a wastewater discharge pipe is welded at a bottom position of an outside of the wastewater connecting pipe, and a wastewater solenoid valve is sleeved on an outside of the wastewater discharge pipe;
a fresh water pipe is connected to the bottom end of the fresh water box, a snap-in groove is provided at a middle position of the bottom end of the fresh water box, and a water inlet hole is provided on the inside of each of the at least one evaporation cell;
a deflector groove plate is welded at a bottom end of the condensate panel, a heat dissipation plate is mounted at a side of the top end of the condensate panel close to the solar panel, an outer side of the fresh water box is welded with a connecting bracket, an end of the connecting bracket is welded with a mounting bracket, and a condensate slot is provided at the bottom end of the condensate panel; and
a waste water tank is provided at a connection position between the inside of each of the at lsea one evaporation cell and the wastewater connecting pipe, and a controller is mounted on the bottom end of the fresh water box.

9. The seawater desalination system for comprehensive utilization of marine energy according to claim 8, wherein two evaporation cells are mounted, the two evaporation cells are symmetrically mounted on the inside of the fresh water box, and two ends of the wastewater connecting pipe are connected to the two evaporation cells, respectively.

10. The seawater desalination system for comprehensive utilization of marine energy according to claim 8, wherein the waterproof solenoid valve, the positioning electromagnet, the rising pressure switch, the falling pressure switch, the conversion pump, input ends of the heating resistance wires, and an input end of the solar panel are electrically connected to an output end of the controller, and an input end of the controller is electrically connected to an output end of the battery pack.
